(19) United States
(12) Patent Application Publication
(10) Pub. No.: US 2004/0083428 A1
(43) Pub. Date: Apr. 29, 2004

(54) Method for providing services using an internet portal

(76) Inventor: Glen Jonathan Slade, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/472,730

(22) PCT Filed: Mar. 21, 2002
(86) PCT No.: PCT/GB02/01359

(30) Foreign Application Priority Data
Mar. 22, 2001 (GB) 0107220.6

(51) Int. Cl. G06F 17/00

(52) U.S. Cl. 715/513

(57) ABSTRACT

A portal electronic site (3) system to aid in navigating and searching particularly on the internet The site supplies to the user one or more electronic pages, at least one of the pages acting as an input page facilitating input of information by the user and at least one of the pages acting as a link page including at least one link to a respective destination electronic site (4). The link page is arranged so that a user is directed to the respective destination electronic site when a link is activated by a user, and the system is arranged so that, provided that the link is activated by the user after the user has input information via the input page, at least some of the information input by the user via the input page is supplied to the respective destination electronic site. The link page may comprise respective links to a plurality of sites and may be arranged so that as user can activate a plurality of links by first selecting the links and then using a link activation object.

This invention relates to facilitating the use of services provided over networks and in particular to improved methods of searching, navigation, and service customisation. The invention is particularly applicable in respect of websites as typically accessed by users via the Internet and in particular the World Wide Web.

As is well known, there is an extremely large volume of information and many different services available via webpages supported by the internet, but it can be difficult for users to find the information or services which they require amongst this vast amount of accessible material.

There are existing mechanisms which attempt to make this task easier. As one example, there are a large number of search engines such as Yahoo or Alta Vista, which allow the input of search criteria and return details of websites which might be of interest. However, such search engines have limited functionality.

As other examples, there are portals which are based around the shopping mall concept. Here a diverse but finite number of selected “stores” are presented to the visitor for easy navigation. Such portals often require registration before use and typically a large amount of personal information is required in the registration process. In some cases, sites visited by a user will be tailored or customised taking into account the personal information provided in the registration process. However, it should be noted that this tailoring or customisation is only carried out on the basis of stored personal information which has been entered during the registration procedure and thus the information is not necessarily up to date and typically will have no particular relevance to the activity which the user is currently performing. Such shopping mall portals can help a user by providing easy access to a number of hopefully high quality sites, but access is confined to a relatively small number of resources and any customisation provided is of limited use.

It is an object of this invention to provide systems and methods which make the task of locating and using appropriate services over a network, such as the Internet and particularly the World Wide Web, more straightforward.

According to a first aspect of the present invention there is provided a method for facilitating use of services provided over a network comprising the steps of:

maintaining a portal electronic site at a central unit;

supplying over the network from the central unit to a user, at least one electronic page, which page facilitates input of information by the user;

accepting at the central unit information input via the page by the user;

selecting at the central unit at least one destination electronic site in dependence on the information input via the page by the user; and

supplying from the central unit to the user at least one further electronic page, which further page includes a link to said at least one destination electronic site.

According to a second aspect of the present invention there is provided a method of operating an end user communications unit arranged for receiving services provided over a network comprising the steps of:

receiving over the network from a portal electronic site at a central unit, at least one electronic page, which page facilitates input of information by the user,

outputting to the central unit information input via the page by the user;

receiving from the central unit at least one further electronic page, which further page includes a link to at least one destination electronic site selected at the central unit in dependence on said information received from the communications unit having been input via the page by the user.

In this application the terms electronic page and electronic site are used to refer to pages and sites which may be accessed and displayed using suitable electronic devices, typical examples are webpages and websites that, for example may be accessed using general purpose computers, interactive televisions etc. The present invention may be implemented in respect of services accessible via the World Wide Web, but is not necessarily limited to such use.

Preferably the method includes the further step of supplying at least some of the information input by the user to the destination electronic site if and when the user chooses to visit the destination electronic site by activating said link. The provision of such information to the destination electronic site can enable the destination site, when suitably configured, to be dynamically customised to suit particular visits.

The information may be supplied to the destination electronic site from the central unit. The information may be supplied to the destination electronic site directly from the user, in particular from the end user communications unit. Here by “directly”, it is meant not via the central unit.

Preferably the further electronic page includes a plurality of links to respective destination electronic sites which have been selected in the selecting step. In such a case, if and when the user chooses to visit more than one of the respective destination sites, preferably at least some of the information input by the user is supplied to each destination site visited. This can allow a user to enter information a single time in a particular session, but have appropriate information provided to a plurality of different destination sites which may be of interest.

Where a plurality of links are included on the further electronic page, it is preferred if the links are arranged by type for display to the user. Preferred types, which may be used alone or in combination include:

product types—which might include brands;

transactors, that is parties that can perform transactions—which might include electronic retailers, department stores, comparison shops, demand aggregators, auctions, brokers such as investment or insurance brokers;

information sources—which might include sources of reviews; and

sponsors—which might be specific to various goods or activities etc.

The further page may be arranged to allow a user to select a plurality of destination sites to be visited and then activate the appropriate links simultaneously by a single action, such as pressing an appropriate button. The user may however, activate links individually, for example by clicking directly on them. Where the further page is arranged to allow a user to select a plurality of destination sites to be visited, the plurality may consist of all links on that page or only a subset of user selected links.

The method may include the step of establishing a session when a first page is supplied from the central unit to the user. This session may be terminated when the user leaves the portal site administered by the central unit, by for example, closing the browser instance used to browse the portal site or visiting a different site using that browser instance. At least some of the information, and in some cases all of the information, input by the user via said at least one page will be retained only for the duration of the session.

Preferably visiting a destination site by activating a link on the further page causes a new window, typically a new browser instance, to automatically open on the user's machine, in which pages from that destination site can be browsed. Preferably, if a plurality of links to destination sites are activated simultaneously, a corresponding number of windows will be caused to open, each to display pages from a respective destination site.

In some cases, the new window may be a virtual window running within the original browser instance rather than a separate new browser instance. Correspondingly window is used in this sense in this application to cover virtual windows as well as new browser instance windows.

According to another aspect of the present invention there is provided a method for facilitating use of services provided over a network comprising the steps of:

maintaining an electronic site at a central unit;

supplying over the network from the central unit to an end user communication unit, an electronic page, which page includes a plurality of links to respective destination electronic sites, wherein the page facilitates user selection of links from said plurality and comprises a link activation object, the link activation object being such that, when operated by an end user it causes a new window to open on the end user communications unit in respect of each selected link.

According to another aspect of the present invention there is provided a method of operating an end user communications unit arranged for receiving services provided over a network comprising the step of:

receiving over the network from a central unit, an electronic page, which page includes a plurality of links to respective destination electronic sites, wherein the page facilitates user selection of links from said plurality and comprises a link activation object, and the method comprises the further steps of accepting user selection of said links to destination sites and in response to operation of the link activation object, causing a new window to open in respect of each selected link. Typically, the new windows will be respective new browser instances, in which pages from the respective destination site can be browsed.

It should be noted, that the electronic page including links may include links to destination sites which do not accept the information that can be provided by the portal electronic site and/or do not have a dynamic customisation facility. It is preferred that links to destination sites which will accept information from the portal electronic site are distinguishable to a user from destination sites that do not accept the information.

Further, the electronic page including links may also facilitate the input of information by a user. In particular, the page may include objects, such as check boxes, which allow a user to express interest in the subject of one of the links or indeed interest in something else. It will be appreciated that a user may express interest in a link without necessarily, visiting, or wishing to visit the associated destination site. As an example, the user may be interested in brandX of camera but merely wish to indicate that interest with the hope that upon visiting a retailer destination site, via the portal, he will be presented with an electronic page selected and/or tailored in view of his interest in brandX.

There may be a plurality of pages presented to the user from the portal site, each of which may facilitate the input of information and/or contain links. In general terms, any page which includes links may also include other elements, such as those necessary to allow the input of information and vice versa. Information input via any page may be forwarded to the central unit and/or a destination site. The portal site may itself be a destination site.

Any page which facilitates the input of information may facilitate the input of one or more different kinds of information. These kinds of information may include either of, or a combination of user specific information and activity specific information.

User specific information will typically include information which is true independent of any activity which the user is currently involved in. The user specific information may be of a general nature such that anonymity is possible, for example, user specific information may include any one of, or any combination of: age, geographic location—instantaneous and/or residence, income bracket, sex. On the other hand the user specific information may be more personal and/or confidential and, for example, may include any one of, or any combination of: name, contact details such as—address/telephone/e-mail, bank details etc.

It is important to note that the present invention may be used without a user having to register or log on and may be used anonymously whilst still providing useful information to destination electronic sites to allow customisation. Having said this, the present invention does cover methods and systems where registration and/or log on is required or available and can provide novel functionality and advantages in such systems. In some cases, at least some of the user specific information will be retained once entered, even if a session is ended. The retained information may be stored at the central unit provided a registration process has been completed and/or in a local cookie. In other cases, however, all information will be lost once a session is ended.

Activity specific information will typically relate to activity for which the user is currently using the network services. Thus in many circumstances, the activity specific information will be relevant only to a specific session. The activity specific information may include further subcategories of information, which may be gathered alone or in combination, ie item specific information and contextual specific information. Item specific information concerns the products or services in which the user is interested for example: cars, holidays, lawyers, cameras, food, investment. The item specific information might be information identifying the general identity of the item, for example “cameras” and/or more specific information about the item of interest, for example, whether or not the camera should have a flash, whether it should be a digital or conventional camera etc. Contextual specific information concerns the reasons why the user is interested in the item, for example the relevant action of interest such as purchasing; consulting reviews, assessments or general information; seeking advice; selling or locating a dealer; and, as another example, the people involved—for example is the purchase for the user, another individual, or a business? and what are the details of that person?

Information may be input via item criteria boxes. The item criteria boxes may be dynamically selected for presentation in dependence on other item specific information input by the user.

According to another aspect of the present invention there is provided a method of targeted promotion comprising the steps of:

providing a user accessible promotion depository;

allowing placing of promotions in the depository;

and controlling the placing of promotions in the depository.

Preferably the depository is accessible via a network, such as the Internet. The depository may be accessible at a portal electronic site. The time for which a specific promotion is accessible to a user may be controlled. Typically the promotions will be places by or on behalf of a third party. A third party may have to pay to place a promotion in the depository. The amount payable may depend on the period for which the promotion is available to the user.

The depository may be associated with a respective user and accessible only by the respective user. A plurality of depositories may be provided each of which is accessible only by a respective user. The number of promotions available to any one user at any one time may be controlled, for example, a maximum of three promotions may be available to a given user at any one time.

The method may comprise the step of gathering information about a user and providing this to a third party to allow customisation of promotions. At least some of this information may be gathered as the user uses a portal electronic site at which the depository is accessible.

According to another aspect of the present invention there is provided a portal electronic site at a central unit for facilitating use of services provided over a network which portal electronic site is arranged for:

supplying over the network to a user, at least one electronic page, which page facilitates input of information by the user;

accepting information input via the page by the user;

selecting at least one destination electronic site in dependence on the information input via the page by the user; and

supplying to the user at least one further electronic page, which further page includes a link to said at least one destination electronic site.

According to yet another aspect of the present invention there is provided a method for tailoring services provided over a network comprising the steps of:

maintaining a portal electronic site at a central unit;

supplying over the network from the central unit to a user, at least one electronic page, which page facilitates input of information by the user;

accepting at the central unit information input via the page by the user;

selecting at the central unit at least one destination electronic site in dependence on the information input via the page by the user;

supplying from the central unit to the user at least one further electronic page, which further page includes a link to said at least one destination electronic site; and

supplying at least some of the information input by the user to said at least one destination site to allow tailoring of the destination site. The information may be forwarded to the destination site directly or via the central unit. Preferably the information is only forwarded to a destination site when the link to that destination site is activated by the user. The method may also include the step of tailoring the destination site.

Where not excluded by context any of the preferred features defined above apply equally to each aspect of the invention defined above, changes being made where necessary for consistency.

According to another aspect of the present invention there is provided a computer program comprising code portions which when loaded and run on a computer cause the computer to carry out any one of the methods defined above or cause the computer to constitute any of the apparatus defined above. The program may be embodied on any machine readable media such as a signal, RAM, ROM or disk.

Embodiments of the present invention will now be described by way of example only with reference to the accompanying drawings in which:

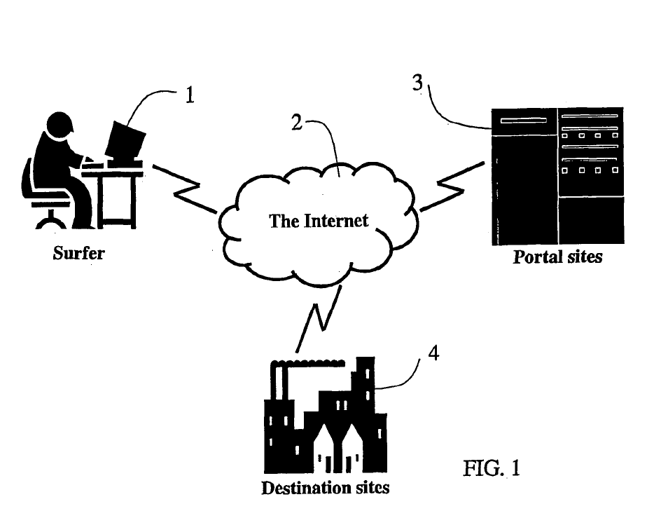

FIG. 1 shows a schematic architecture of the internet as used in an embodiment of the present invention;

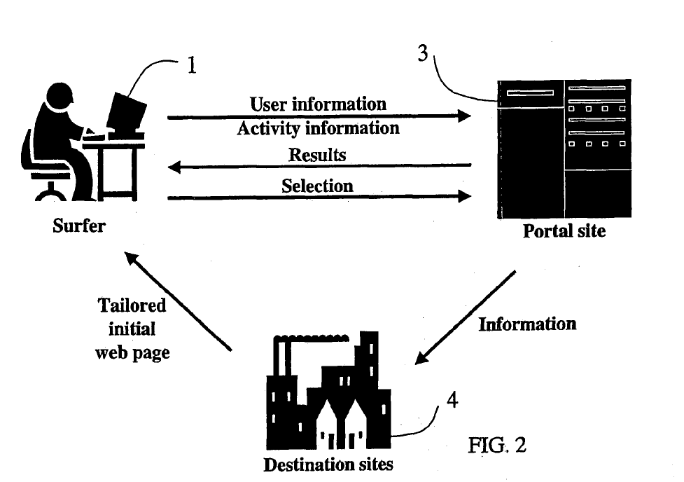

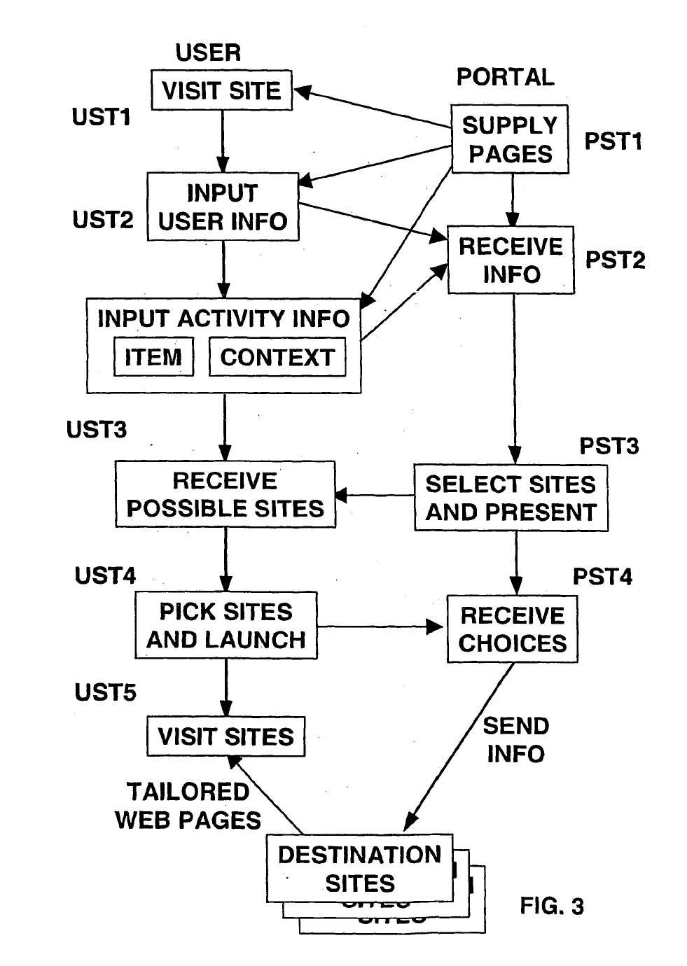

FIG. 2 schematically shows interaction between a user, a destination website, and a portal website in an embodiment of the present invention;

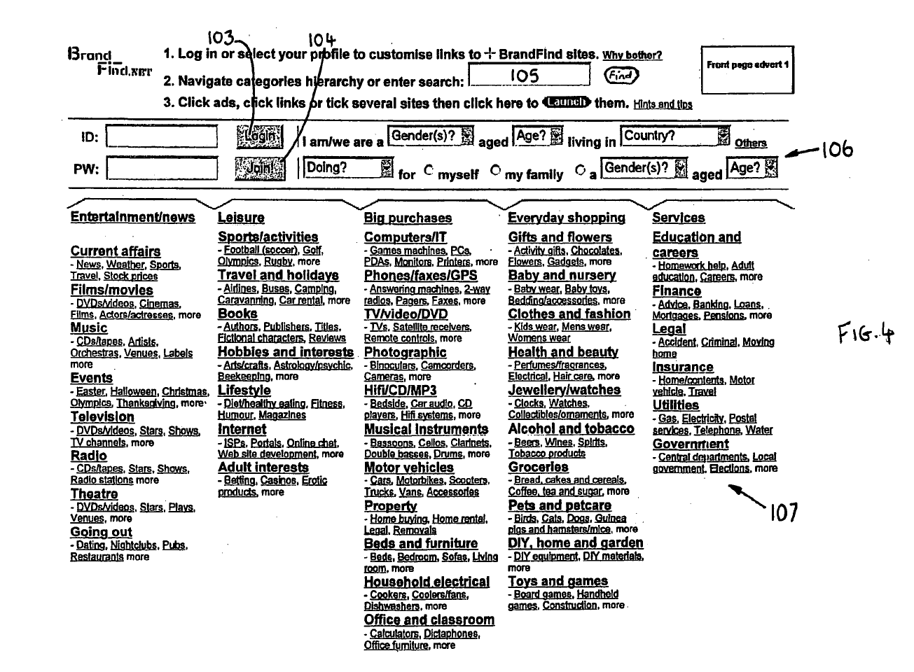

FIG. 3 schematically shows the processes followed by a user and at the portal website;

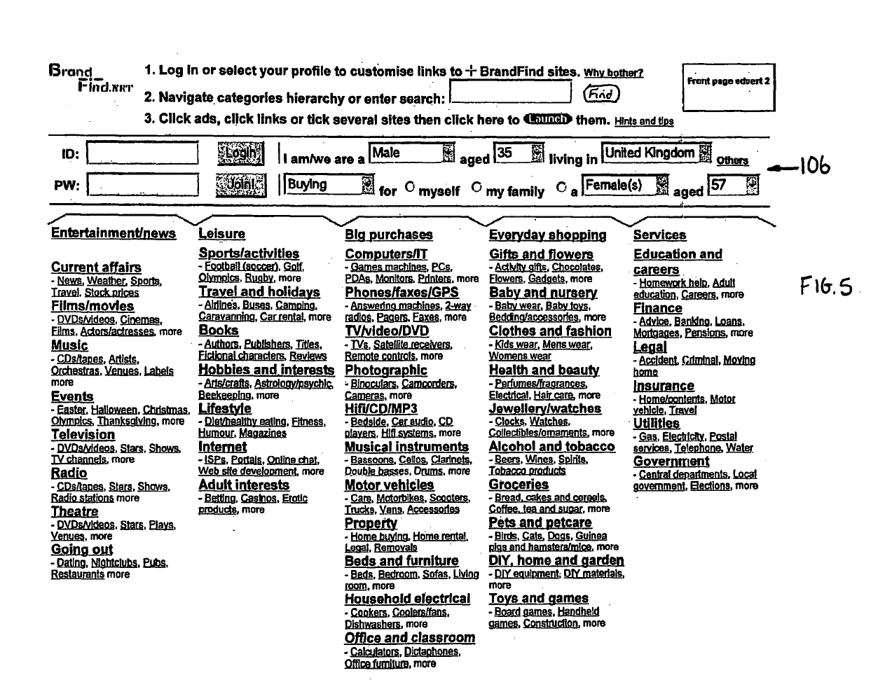

FIG. 4 shows a home page of the portal website;

FIG. 5 shows the home page shown in FIG. 4 with some information completed;

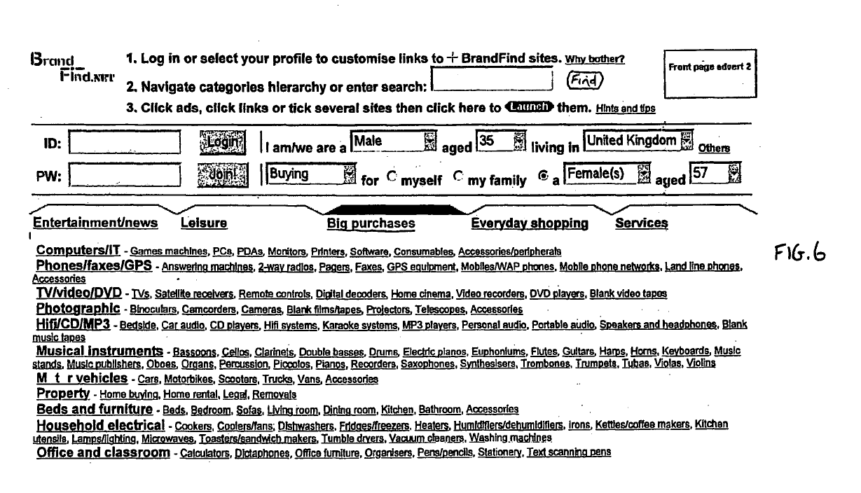

FIG. 6 shows a set of categories under the heading “Big Purchases”;

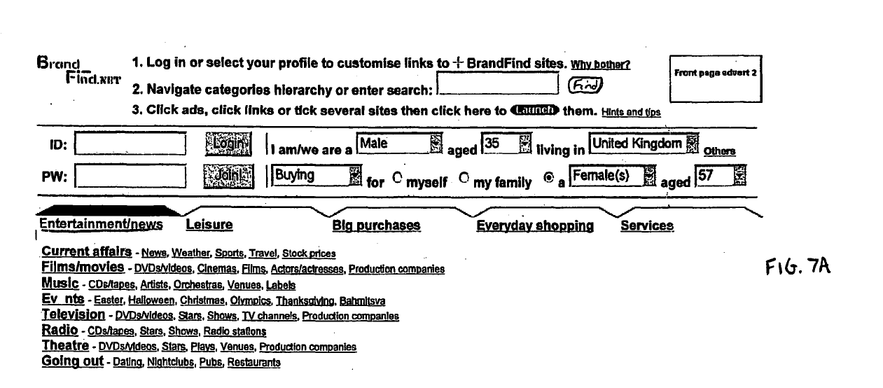

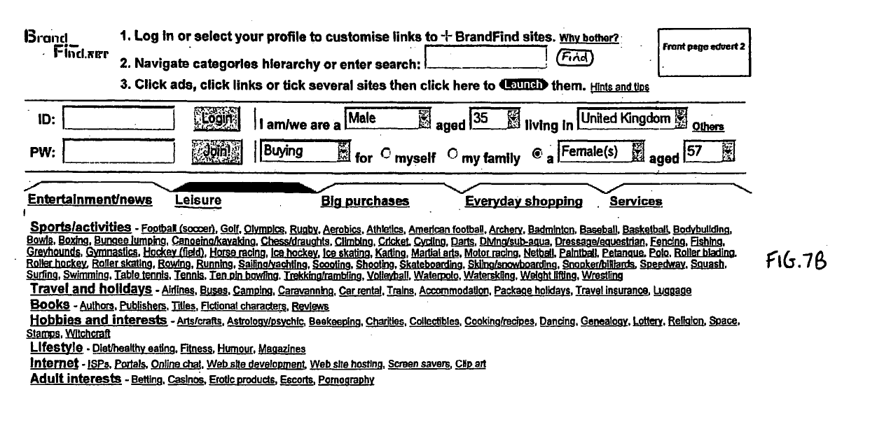

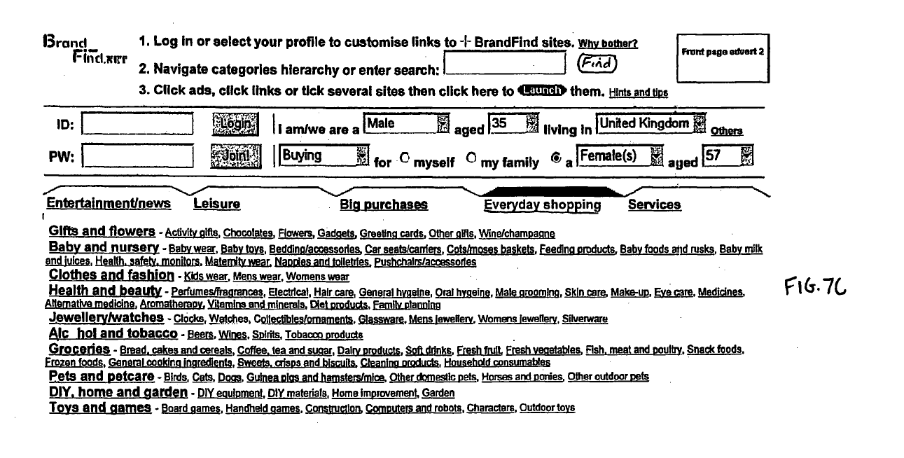

FIGS. 7A to 7D shows sets of categories under other headings;

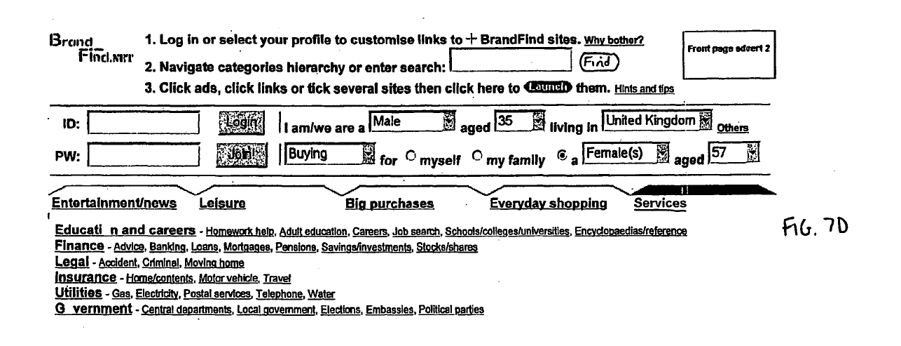

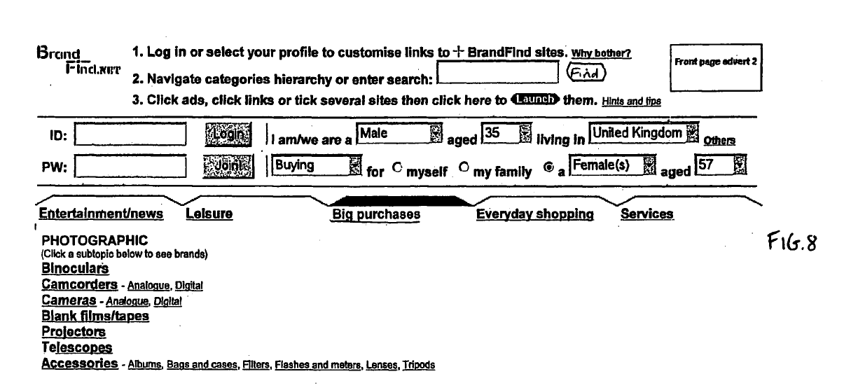

FIG. 8 shows a webpage displayed after the options “Big Purchases” and “Photographic” have been selected;

FIG. 9 shows a webpage displayed after the link “Cameras” has been selected;

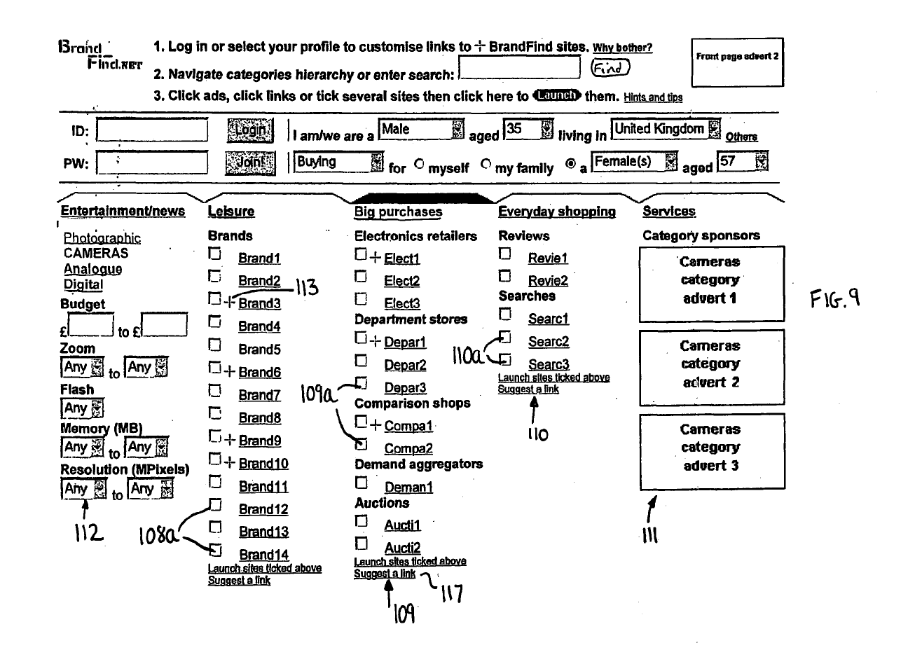

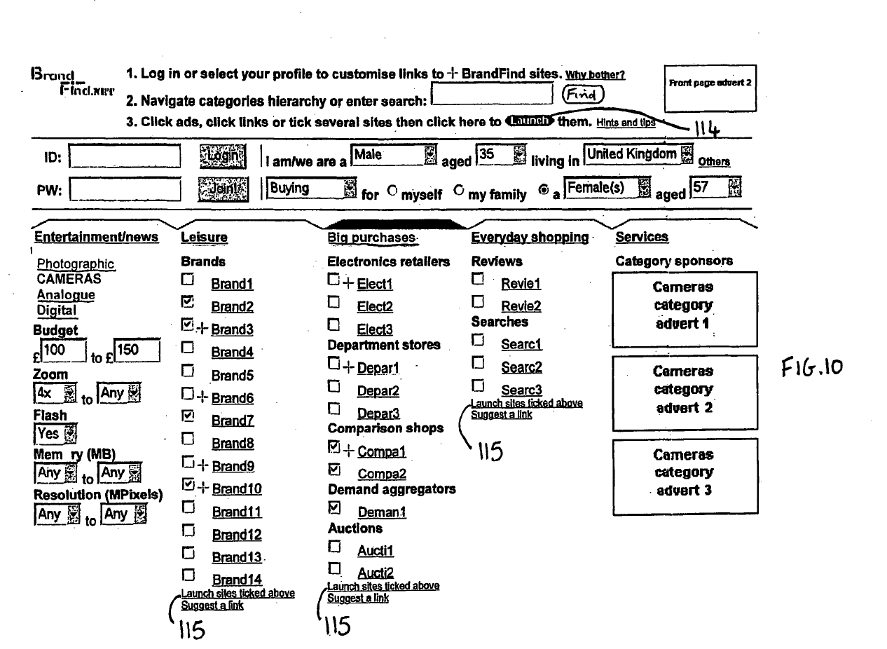

FIG. 10 shows the webpage of FIG. 9 after a user has selected various items in which he is interested;

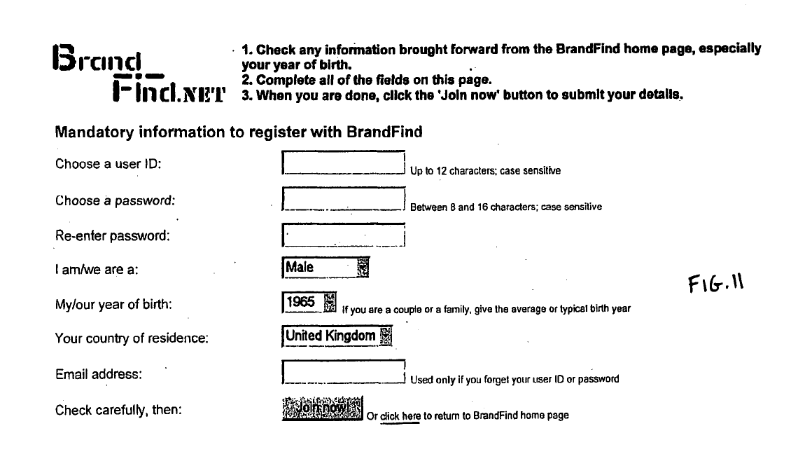

FIG. 11 shows a webpage displayed after a user has clicked a “join” button;

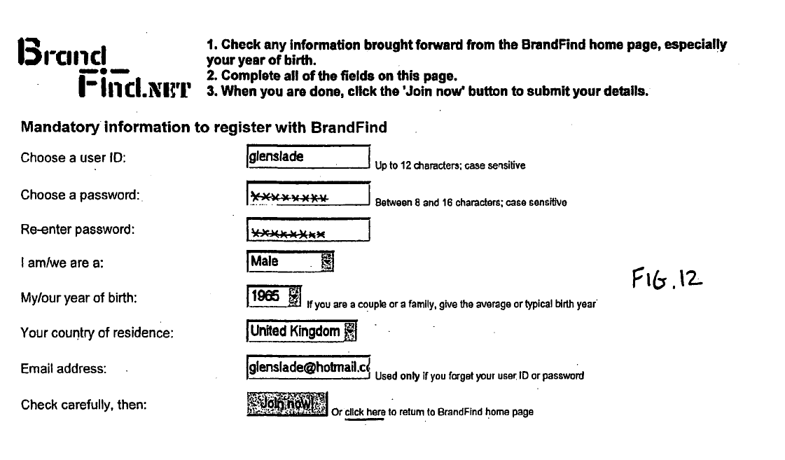

FIG. 12 shows the webpage of FIG. 11 once requested information has been completed;

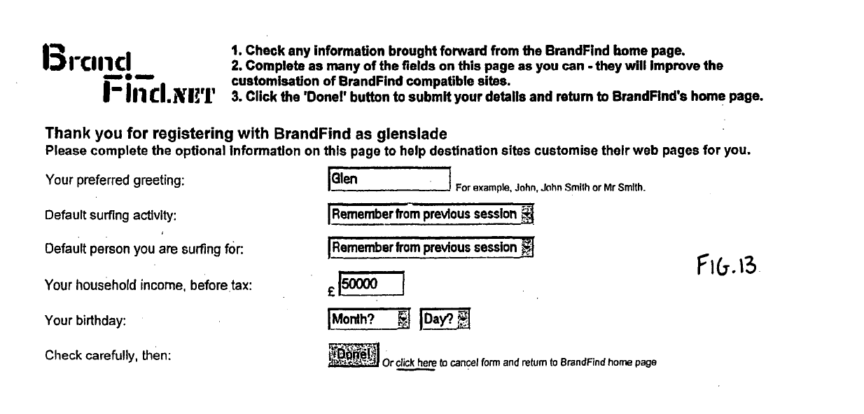

FIG. 13 shows a webpage displayed if a user clicks on a “join now” button; and

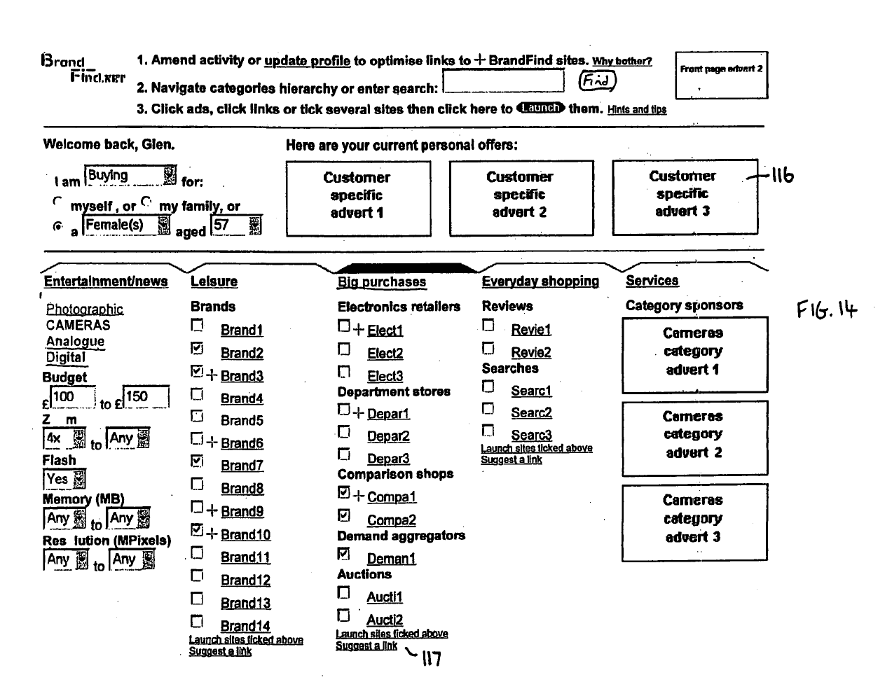

FIG. 14 shows a webpage displayed at the end of a registration procedure.

FIG. 1 schematically shows architecture of the internet which may be used in the carrying out of the present invention. A user (or surfer) has an end user communications unit 1 which is connectable to the internet 2. In turn a portal site 3 and a plurality of destination sites 4 (only one of which is shown in FIG. 1) are connected to the internet 2. The portal site 3 will typically comprise a website supported by a web server which acts as a central unit in the present systems and methods. Similarly the destination sites 4 typically comprise websites supported by respective webservers.

In accordance with widely known conventional technology the user (or surfer) may access electronic sites and particularly view electronic pages provided by electronic sites via the internet 2. Currently the most usual way this is carried out is by making use of the World Wide Web. In such a case the user will view webpages from the portal 3 and destination sites 4 using a browser (such as Netscape Navigator or Microsoft Internet Explorer), which runs on his communications unit 1. Of course many other users may connect to the portal 3 and destination sites 4 using respective equipment. The present invention is applicable to any type of service provided over a network where a user is able to access portal sites and destination sites and receive electronic pages. However, for the sake of clarity and simplicity the remainder of the description will be written in terms of the World Wide Web, websites, and webpages.

It will be appreciated that the webservers supporting the websites 3, 4 and the communications units 1 will comprise generally conventional hardware and much conventional software to allow operation. Each of the communication units 1 and the webservers will comprise data storage means and data processing means amongst other components. Moreover, the communication unit 1 will comprise a display and user input devices. The communication unit 1 may, for example, comprise a general purpose personal computer, or an interactive television system.

Portal websites in their broadest sense, including search engines such as Yahoo or internet service provider sites such as AOL, are well known. However, the present application relates to methods, systems and apparatus where a heightened level of functionality is provided via a portal site.

Referring to FIG. 2, the portal site 3 of the present application functions generally as follows. The user accesses the portal site 3 using his communications unit 1 and is presented with a webpage through which the user may input user information and activity information. User information concerns the user and activity information specifically relates to the activity in which the user is currently interested. Thus, for example, the user information may include a geographical location at which the user is based and the activity information may include an indication that the user is interested in purchasing a camera.

Based on this input information, the portal 3 selects a number of destination websites which may be of potential interest to the user and delivers an appropriate webpage to the user's communications unit 1 including links to these destination websites 4. In response to the page including the choice of links, the user may select links which are of interest, for example by clicking on the appropriate link. Information concerning the user's selection is then forwarded to the portal site 3 by the communication unit 1. The portal site 3 then carries out two actions.

The first action is to direct the user to the appropriate destination site(s) 4 and the second is to provide at least some of the information input by the user onto the selected destination site(s) 4. This information supplied to the respective destination sites 4 can be used to select and/or tailor the webpage which is first sent to the user from that destination site 4.

Thus, it will be seen that in contrast with a conventional portal, such as a search engine, rather than just directing a user to a website, useful information concerning the user, and the activity in which they are interested, may be passed to the destination site 4 to enable the destination site 4 to provide the user with a webpage which is hopefully of particular interest and/or use to the user.

It should be appreciated that the flow of information shown in FIG. 2 represents a simple level on which the present methods, systems and apparatus may operate. For example, in developments, the portal site 3 may provide limited information to the destination site 4 at an initial stage, and retain some of the input information until specific authorisation is given by the user. This might be facilitated by the user selecting and activating an appropriate button on a destination webpage if the user decides that he is willing for additional information to be handed on to the destination site 4.

Further, there may be an exchange of information between the destination sites 4 and the portal site 3 to ensure that the portal site 3 is kept up to date on the state of destination site 4 information content and services such that the portal 3 may suggest currently appropriate links to the user.

FIG. 3 shows more of detail the processes which occur when a user interacts with the portal site 3 using his communications unit 1. Whilst FIG. 3 shows more detail than is shown in FIG. 2, it will be appreciated that it is still only a simplified schematic representation of the processes which occur and it is not essential that the steps occur in the order shown, or only in the order shown.

At step UST1 the user visits the portal site 3 home page, and to allow this to occur the server supporting the portal site 3 supplies an appropriate electronic page (or pages) to the end user's communications unit 1 in portal step PST1.

The page or pages supplied to the user allow the input of user information and activity information and in steps UST2 and UST3, the user inputs the appropriate information. This information is output by the user's communications unit 1 and received at the portal site in step PST2.

It will be appreciated that the actual user information input and the actual activity information input will depend on the nature of the questions which are asked in the page(s) supplied in step PST1 and will further depend on the user and his interests.

However, the user specific information will typically include information which is true independent of any activity which the user is currently involved in. The user specific information may be of a general nature such that anonymity is possible, for example, the user specific information may include any one or a combination of age, geographic location, income bracket, or sex. On the other hand the user specific information may be more personal and/or confidential and for example, may include any one of, or any combination of, name, contact details, or bank details.

In contrast to this, the activity specific information will typically relate to an activity in which the user is currently interested, and in particular, the reasons why the user is currently using or attempting to use a network service. Thus, in many circumstances the activity specific information will be relevant only to a specific session. As illustrated in FIG. 3, the activity specific information may include further sub-categories. In the present embodiment the activity specific information can be sub-categorised as item specific information and contextual specific information. Item specific information concerns the products or services in which the user is interested, for example, cars, holidays, lawyers, cameras, foods or investment. The item specific information might be information identifying the general identity of the item, for example “cameras” and/or more specific information about the item of interest, for example, whether or not the camera should have a flash, whether it should be a digital or conventional camera etc. Contextual specific information, on the other hand concerns the reasons why the user is interested in the item, for example, if the user interested in purchasing an item, finding out information about an item or selling an item. Contextual information may also relate to the people involved, for example, is the user interested in purchasing an item for himself or for another person.

Referring back to the processes illustrated in FIG. 3, in response to the information received at the portal site 3 in step PST2, the portal site 3 is arranged to select various destination sites 4 (and possibly other options) which, based on the received information, would appear to be of potential interest to the user. The portal 3 supplies a further page to the user's communication unit 1 which include links to the selected destination sites 4. This further page may also the permit the input of further information by the user, it is most likely that this information is activity specific information. Any such further information may be used by the portal 3, in the selection of pages or objects to be presented to the user and/or may be included in any information forwarded to destination sites 4 as described in more detail below. This selection and page sending operation occurs in step PST3 of the process and the further page is received at the user's communications unit in step UST4.

On receipt of the further webpage, the user can consider which of the presented destination sites 4 are of interest. Once the user has selected the options in which he is interested he may, in step UST5, activate the selections. The selections made and activated by the user in step UST5 are sent to the portal site 3 where they are received in step PST4.

In response to the user's selections, the portal site 3 connects the user to the appropriate destination site(s) 4 and a separate browser instance will open on the user's communication unit 1 for each destination site 4 selected. At the same time, the portal site 3 forwards at least some of the information input by the user to the selected destination sites 4 to allow the initial webpage provided by each selected destination site 4 to be selected and/or tailored in dependence on the forwarded information.

As mentioned above, it should be noted that when a user picks and activates links to destination sites 4 which have been suggested by the portal site 3, contact with all of the selected sites 4 is initiated simultaneously (via the portal in this embodiment), and separate browser windows will open for the respective sites 4. This ensures that the user does not have to manually visit the sites, one after the other, and ensures that the appropriate information gathered by the portal site 3 can be forwarded onto each destination site 4 that is selected and visited by the user.

Since the destination sites 4 are reached via the portal 3 in this embodiment, the portal 3 can maintain a log of sites visited which is useful for purposes such as charging the owners of co-operating destination sites 4. However, it should be noted that once the user is referred onto the destination site(s) 4, the initial web page is supplied directly from the respective destination site 4 and the portal 3 is no longer involved in the user's interaction with that site 4. In an alternative however, the initial web page and possibly all other web pages from the destination site 4 may be fed through the portal 3. This can help to ensure the user's anonymity.

In an alternative implementation, rather than the user reaching destination site(s) 4 via the portal 3, activation of the appropriate hyperlink(s) can lead the user directly to the destination site(s) 4. In such a case the information for selection and/or tailoring of the destination site(s) might be embedded in a page sent from the portal 3 to the user's communication unit 1 and forwarded to the destination site 4 by the user's communication unit 1 as the destination site 4 is visited. Alternatively, the user's communication unit 1 might forward a session code to the destination site 4 to enable the destination site to retrieve the information from the portal 3.

FIGS. 4 to 14 show webpages as provided from the portal site 3 of the present application to an end user communications unit 1. The majority of pages relate to a specific case where a user is interested in purchasing a camera for his mother.

FIG. 4 shows the default home page of the portal website 3. It can be noted that this page provides the option to the user to log in if they are an existing member or to join, i.e. register, with the portal website 3 if they are not a member. However, both of these courses of action are optional and registration is not a requirement for using the website portal 3. Furthermore, in the present example we run through the pages which a user would visit when interested in purchasing a camera without registering with the portal 3.

The webpage in FIG. 4 comprises ID and password fields 101, 102 and log in and join buttons 103 and 104 which are relevant if a user is a registered user or is interested in registering. The webpage also includes a search data entry field 105 which again is not going to be used in this current example.

The webpage also includes a number of data entry fields 106 which allow the input of user specific and activity specific information. In particular, there is a field for the user to input a gender, or to indicate that the user is a group such as a family; for the user or users to enter a representative age; and for the user or users to enter the geographical location in which they live. It will be noted that these first three fields all relate to user specific information.

There is a further field to allow the user to indicate what they are doing. For this field, in the present embodiment, the user is allowed to select from the options “purchasing”, “seeking information”, or “having fun”. It will be appreciated that in other embodiments, different options may be provided. Further, in the present embodiment, it is possible to indicate in relation to whom this act is being carried out, and to give further information about that person, in this case their gender and age. It will be noted that these pieces of information are activity specific information and more particularly are contextual information, that is to say they relate to the surrounding circumstances of the action being carried out rather than the item of interest.

In the present embodiment, further activity specific information and, in particular, item specific information may be entered by clicking on the appropriate hypertext links shown in the columns 107 headed “Entertainment/News”, “Leisure”, “Big Purchases”, “Everyday Shopping, Services”. It will be noted that the hypertext links in these columns 107 generally relate to item specific information. It should also be noted that each of these columns 107 are the top level of a hierarchical categorisation structure and thus there are other levels of categories below those shown in FIG. 4. It is possible for a user to progressively drill down through these levels to more specifically indicate the items in which they are interested.

FIG. 5 shows the webpage of FIG. 4 but with some information completed by our user who is interested in buying a camera. Thus, as shown in FIG. 5, the user has entered the fact that he is a male, age 35, living in the United Kingdom and is interested in buying something. Furthermore, the user has specified a female or females aged 57. The user has failed to indicate whether they are acting on behalf of themselves, their family or a particular person. However, since the details of the particular person, i.e. a gender and age has been selected, when this page is received and processed by the portal site 3, it will be assumed that the purchase is to be made for a female aged 57.

FIG. 6 shows the webpage after the user has clicked on the “Big Purchases” column. It will be noted that on the webpage shown in FIG. 6, there are more hypertext links relating to the category of “Big purchases” than are included in the webpage shown in FIG. 4. This is simply because there is more room available for showing hypertext links relating to big purchases when those relating to the other main headings are not being shown.

FIGS. 7A to 7D show the webpages which would be displayed if the user selected the other main headings, namely “Entertainment”, “News”, “Leisure”, “Everyday Shopping” and “Services”.

Returning to our example interaction, it will be remembered that our male user is interested in purchasing a camera, therefore from the selection of hypertext links shown in FIG. 6, the user clicks on the “Photographic” hypertext link and is then presented with the webpage shown in FIG. 8. Included amongst the list of items below the heading photographic is a hypertext link for “Cameras”. As the user is interested in a camera he next clicks on this hypertext link and is then presented with the webpage shown in FIG. 9.

It will be noted that although our user has progressed through the various webpages shown in FIGS. 5, 6 and 8 before reaching the webpage shown in FIG. 9 this series of steps is not essential. Since “Cameras” was one of the hypertext links shown under the big purchases category heading in FIG. 4, it would have been possible to click on this hypertext link and arrive at the webpage shown in FIG. 9 directly.

It will be noted that the webpage shown in FIG. 9, differs significantly from that shown in the preceding Figures. This is because the user has now drilled down sufficiently far that a meaningful suggestion of destination websites 4 can be made to the user. In this particular case, the point at which it has become feasible to make suggestions is when the user has selected cameras. However, it will be noted that under the word cameras there are hypertext links to “analogue” and “digital”. Thus, if the user so desired, he could restrict his search and the suggested destination sites, to one of analogue or digital cameras. He would then be presented with a page which was similar to FIG. 9 but which showed slightly different suggested sites.

Referring again to FIG. 9, it will be noted that there is a first column 108 headed brands which includes a list of 14 brands each of which is a brand of camera. As well as the brand name (here replaced with brand1, brand2 etc) there is a check box 108a which the user can tick if he is interested in that particular brand. On the other hand it should be noted that each of the brand names is also a hypertext link and if, for example, the user is interested in brand4 alone, he could click directly on the hypertext link for brand4 and go straight to their website. It should be noted that ticking a brand check box 108a is an action by which the user is entering yet more activity specific, and in particular item specific, information.

A second column 109 consists of transactors, that is parties who are able to carry out transactions. In this case these are sub-divided into electronic retailers, department stores, comparison shops, demand aggregators and auction sites. Again, in each case the name of the transactor is a hypertext link which could lead the user direct to the respective destination site 4, but there is also a check box 109a which the user can use to indicate his interest. This again would result in the user providing what can be considered activity specific information. As an example where a user ticks boxes 109a in respect of say two retailers, the fact that the user has expressed an interest in one of the retailers might be provided to the destination site 4 of the other retailer, and that destination site 4 might be tailored accordingly.

A third column 110 includes a list of information resources. This is broken down into the sub-categories of reviews and searches. Again tick boxes 110a are provided.

In a fourth column 111, there are a number of category specific adverts which may be of interest to the user. Each of the adverts is also a hyperlink to-an appropriate destination site 4, which might be configured to receive and act upon information from the portal 3 if clicked on by a user.

Although each of the columns 108, 109, 110, in this example, include only hypertext links, this is not essential. If for example, no website can be found for BrandX this could still be provided on the page with a check box for a user to tick. Of course, a retailer might stock BrandX and by ticking the box, the user may in effect be indicating his interest in BrandX to a selected retailer when visiting the retailer's destination site 4.

Further on the webpage shown in FIG. 9, there are a plurality of item criteria boxes 112 which the user can use to further specify the product in which they are interested. In particular, there are budget boxes in which a user can specify a minimum and maximum price, as well as boxes concerning features of the camera such as its zoom capability, whether or not it has a flash, its memory (assuming it is a digital camera) and its resolution (assuming it is a digital camera).

It should also be noted that indicator cross-hairs 113 are included alongside some of the hypertext links to websites of interest. These indicator cross-hairs 113 indicate to a user that the website concerned is configured to make use of the additional information which the website portal 3 is able to collect and pass on to destination websites. Ihus, if a user visits one or the websites alongside which there are indicator cross-hairs 113, he can expect that the web page presented to him upon activation of the hypertext link, will be tailored or customised to take into account at least some of the information which he has provided. Thus, in general terms, websites which have the accompanying indicator 113, should be of more interest to the user. However, it will be noted that destination websites that do not have the capability to react to the information provided to the internet portal 3, can still be selected and visited by the user.

FIG. 10 shows the web page of FIG. 9 after the user has marked certain of the check boxes 108a, 109a, to show that he is interested in those websites, and also after he has completed some of the item criteria boxes 112.

Now that the user has marked some of the check boxes 108a, 109a there is a choice in the way in which he proceeds.

Firstly, the user could click the launch button 114 provided near the top of the page. Doing this would automatically open new browser windows in respect of each of the user selected destination sites 4 to allow the user to look at each site in turn.

Alternatively, the user could click on the “Launch sites ticked above” buttons 115 provided at the foot of the three main columns in order to visit only the sites included in the respective column. If this option is chosen, then again separate browser windows will open in respect of each of the ticked destination sites 4 in the respective column 108, 109, so that each site may be individually visited by the user.

As a further alternative the user may choose to click directly on any of the links in which lie is interested and proceed to that site alone. If this is done then the checked boxes 108a,109a still constitute an indication of his current interests, ie activity specific information, and this can be passed to a destination site 4 which he visits by directly clicking on the appropriate individual link. For example, if the user clicked on the “Elect1” link, the destination site 4 of this retailer might be informed of the user's interest in Brands1,2,7, and 10, and tailor the page delivered to the user appropriately.

As noted above, the example described with respect to FIGS. 4 to 10 was carried out without the user logging in or registering with the portal website 3. However, at any time a user may decide to register with the portal website 3 by clicking the join button 104.

FIG. 11 shows the page which is presented to a user upon clicking the join button 104. It can be noted that this page includes several fields which must be completed if the user is to register with the portal website 3. FIG. 12 shows an example of this page as completed with a user's information.

FIG. 13 shows a page which is presented to the user after he has completed the mandatory registration page shown in FIGS. 11 and 12. Here further optional information may be provided for use by the portal website 3.

At the end of the registration procedure the portal 3, presents the user with a page which is similar to that which he was viewing when he began the registration procedure by pressing the join button 104. FIG. 14 shows the web page which would be presented to our example user at the end of the registration procedure. This is the same as that he would be presented with if he returned to the portal website 3 at a later time having followed through the registration procedure and selected options such the portal website 3 returns to the last presented web page when revisited. In the present case, the user is represented with a cameras selection page similar to that shown in FIG. 9 but with some modifications.

In the modified web page as shown in FIG. 14, there is no longer any need to include the registration fields and buttons 101 to 104. Furthermore, the user is presented with three customer specific adverts, these adverts 116 in fact consist of time limited special offers available to the particular user. These special offers will be provided by third parties and typically will be selected for presentation on the basis of information which has been gained by the portal website 3. A third party pays to have his special offer presented to a selected user or users for a predetermined period. If the user accesses the internet portal website 3 during this period he can take up the offer. Whether or not the offer is taken up by one or more users, it will be removed from the web page shown in FIG. 14 once the predetermined period has expired. In the present case since the user has shown an interest in buying a camera, then one of the customer specific adverts 116 might relate to a special offer for purchasing a camera but the adverts might be of a more general nature.

Each of the adverts 116, is also a hyperlink to a destination site 4, which sites 4 will typically be arranged to be capable of receiving information from the portal 3 in the way described above.

It is important to note that customer specific adverts are made available to the user by the system operator implementing a promotion depository system. Each depository is specific to and accessible by the user and only the system operator can place promotion objects in the depository for display to the user. Each promotion object can have one of a number of associated properties including an expiry date, a priority (relative to other promotion objects), view count, click count, etc. Information about the user may be used to decided if promotion should be provided to a user and the promotion may be customised.

As an alternative rather than the promotions being presented automatically on log-on as adverts, the promotions may be located on a separate pages accessible via a link. Each user's depository may be limited in size to prevent a continual build up of promotions.

It should be noted that the web pages shown in FIGS. 9 and 14, include a “suggest a link” hyperlink 117 which allows a user to suggest a link which should be added to the categories to promote evolution of the database in response to customer needs.

Although not described in detail, in the present application, it will be appreciated that in order for the major benefits of the present portal website 3 to be realised, it is necessary for a significant number of destination sites 4 to have the capability to receive information gathered by the portal website 3 and select and/or modify web pages for presentation to users in response to this information. It is envisaged that generally conventional software for the dynamic generation of web pages will be provided at or in conjunction with the enabled destination sites 4 to make use of the information which can be provided by the portal website 3 of the present application. In some cases an expert system may be provided for enhanced capabilities. Further as is clear from the above description, the information provided to one enabled destination site 4 may be different from that provided to another destination site 4. For example, the information supplied may depend on requests made by the owners of the destination site, possibly accompanied by appropriate payments, and/or in dependence upon decisions made at the portal 3.

A wide variety of user specific and/or activity specific information is potentially available for forwarding to a destination site. For example in the case described above, a destination site could be informed of the fact that a user is interested in buying a camera, is based in the UK and that the camera is a gift for another person. Further a retailer could be provided with an indication that the user is interested in a “brand3” camera or a “brand7” camera etc.

It will be appreciated that when a user registers with the portal website 3 then there is essentially no limit to the types of information that may be stored in respect of that user. Thus, in addition to the main functionality described above where information regarding a specific session, and particularly the activities which are of current interest to the user are considered, it is also possible for the portal website 3 to retain information such as names, addresses and bank or credit card details which could be selectively provided to destination sites 4. Thus, where a destination site 4 is configured to work in conjunction with the portal website 3, the destination site 4 might include a button which when pressed by a user would effectively authorise that destination site to seek and receive data such as credit card details etc., from the portal website 3 in respect of that user.

In a further development, it might be possible for individual destination sites 4 to continue to collect data concerning the usage made by the user and return this to the portal website 3.

Although the above description has been written in terms of a detailed situation i.e. in relation to a user interested in purchasing a camera, the present invention is by no means limited to such use. Thus, for example, the invention might be used by individuals for a whole variety of different purposes not just limited to purchasing items and furthermore may be used in a business to business environment.

The portal website might also be used in implementing a points for surfing scheme, where points are awarded to users according to the number of sites visited through the portal.

It should be appreciated that the present system allows a user to input information concerning both themselves and the activity in which they are interested. Further this information is entered a single time in a session but all of it or any parts of it can be provided to and used by a number of totally independent destination websites. At the same time there is no necessity to register with any organisation.

Thus the present system can greatly ease the process of using the World Wide Web and avoid the inconvenience of having to register with organisations and perhaps provide them with more information than you are willing.

It will be appreciated that, with the system described above, in a number of circumstances, electronic pages are provided which both allow a user to input information and include links to destination sites. Further the information input by a user via such a page may be forwarded to the appropriate destination site upon activation of the link. This process can occur without there being any need for links to be selected for presentation to a user and might occur, for example, where popular links are provided on the system home page, or where another system page is accessed directly for example via a search engine or a bookmark.

Another contemplated functionality of the system is that information input by the user may be used to select a particular page at a destination site to which the user is directed on link activation. To put it another way, the system may be arranged so that after the user has input information via an appropriate input page, the user is directed to a URL which results in the destination site displaying a page reflecting at least some of the information input by the user via the page.

The selection of a particular page may occur at the user's machine and/or at the portal website in addition to or in alternative to any tailoring which occurs at the destination site.

In this way some of the links shown on pages supplied to the user may be considered general links or dynamic links. Furthermore it will be seen that information entered by the user after a page of links has been presented may be used in selecting a page to which a user is directed and/or used in customising that page. Such information may entered via the same page which includes the link or links to be activated.

In an alternative rather than the hierarchical categories of items as shown in, for example, FIG. 5, the item hyperlinks may be categorised on a network model.

In another alternative, a default value for the country of the user could be inferred or guessed from the IP address. Moreover, if a user is accessing the portal site 3 from a GPS (Global Positioning System) enabled communications unit 1, the exact location might be made available to the portal website 3. However, whenever one of these techniques is used, it would generally be possible for the user to override any inferred location.

In further alternatives other activity specific information may be sought in addition to, or alternative to that mentioned above, and appropriate user entry fields provided on the web pages. For example, there may be a timing field so that a user can indicate when a certain action is to be carried out.

In a development, the category sponsor adverts 111 included in the web page shown in FIG. 9 could be adapted dynamically in response to information input into the item criteria fields 112. As an example, initially there might be an advert relating to a camera but if the user then specifies that the camera must have a flash, the advert could change so as to relate to a camera with a flash. This change could occur almost simultaneously with the user indicating that he requires a flash. The website portal 3, in some developments may be arranged to apply intelligent rules to create default criteria to be used in the criteria fields 112.

In some developments, even if a user chooses not to join or register with the portal website 3, some of the information input during a session may be stored in a local cookie at the browser for automatic reloading or prompted reloading next time the portal website 3 is visited.

In developments, there may be a facility for the portal website 3 to request further information of registered users at certain points and/or to offer the facility to modify the currently stored data by selecting an update profile option.

In alternative implementations, at least some of the software required for interacting with the portal website 3 may be downloaded onto the end user communication unit 1. This could speed up browsing for the user. For example, a category list file or other data might be stored at the communication unit 1 such that some operations could be carried out without the need to contact the portal website 3.

In other developments, specialised links could be provided on web pages supplied by the portal website 3 to the user. For example, a list of sites recently visited by the user could be provided and/or a list of sites recently the subject of TV or radio adverts, or indeed any other adverts, might be provided. In each case, tick boxes would be provided alongside these links and the facility to launch some or all of the links simultaneously, as well as individually, would be provided.

In yet a further development, rather than simply allowing a user to specify a type of product and/or a brand in which they are interested, the user could be allowed to specify the exact product of interest, for example a specific model of camera. If this is the case, then an option would be for the portal webside to provide barcodes (or other product identifiers) to destination sites so that the user could be provided with even more specific information such as whether a particular product is in stock and the price at which it could be offered.

In a further development, user preferences can be available for specification by a user. In particular, it is envisaged that a user may be able to select the type of sites which he wishes to be included in selection lists of the type shown in FIG. 9. For example, a user may specify that he is not interested in seeing the inclusion of any names, brands, transactors, etc., which are not a hypertext link, i.e. brands or transactors where direct access to a respective website is not available. Alternatively, a user may be allowed to specify that he does not wish to be presented with lists of brands or transactors etc., who do not have the capability to receive and act upon the portal website 3 information.

In some cases there may be information that is activity specific information which cannot be classified as item specific or contextual specific. Any such information can be included in the gathering or forwarding processes described herein.

In the system described above, when a plurality of links to different destination sites are activated, a separate browser window is opened for displaying pages from each destination site. This is achieved by launching a separate browser instance to provide each window. In an alternative, rather than opening a separate browser instance for each visited destination site, the separate windows may be virtual windows. In this way a separate window is opened for each site although all of these virtual windows run within the original browser instance.

In another alternative the number of windows launched per activated link may be other than one. In some cases the system may determine that no window should be opened in respect of a particular link. This might be the case, for example, if the linked site cannot provide a desired product. In other cases two or more windows may be opened in respect of a particular link—this might be appropriate, for example, in a case where a retailer destination site can provide two or more different brands of interest—an appropriate number of windows may be opened so that there is one window per brand.

In the example described above mention is made of the fact that links may be marked to indicate whether the destination site is able to make use of the information forwardable by the system. In a development a number of different indicator marks may be used to indicate differing levels of use that will be made of the information.

It can be considered that the operation of navigation in respect of available network services, especially the World Wide Web is distinct from the operation of searching. It is considered that navigation may be carried out when you know what you want or where you want to get to, but you do not know how. On the other hand searching carries an implication that you are unsure of what you want or where you need to go. Whilst the systems, methods and apparatus of the present application can be used for both searching and navigation, it is considered that the navigation aspects are particularly important.

1. A method for facilitating use of services provided over a network comprising the steps of:
maintaining a portal electronic site at a central unit;
supplying over the network from the central unit to a user, one or more electronic pages, at least one of the pages acing as an input page facilitating input of information by the user and at least one of the pages acting as a link page including at least one link to a restive destination on electronic site;
the method comprising the fu steps of:
i) arranging the page so that a user is directed to the respective destination electronic site when said at least one link is activated by a user, whereby the user can browse pages from the respective site; and
ii) provided that said at least one link is activated by the user after the user has input information via the input page, arranging for at least some of the information input by the user via the input page to be supplied to the respective destination electronic site, wherein
the step of supplying at least one electronic page comprises the step of supplying a con:on electronic page which common page acts as both an input page and a link page, and is further arranged so that information input via the common electronic page by a user after the common page has been supplied is useable in determining a particular page of a desertion site to which the user is directed upon activation of the respective link in said common electronic page.

2. A method according to claim 1 comprising the further step of forwarding said information input via the common electronic page to a destination site for use in selecting said particular page of the destination site.

3. A method according to claim 1 comprising the step of using said information input via the common page at a user's machine to determine said particular page of the destination site.

4. A method according to any preceding claim in which there is no direct interaction, between the central unit and the respective destination site, involved in the supply of said at least some of the information to the respective destination site.

5. A method according to any preceding claim in which the common electronic page comprises a plurality of links, each link linking to a respective destination site, and the common electronic page is arranged so that said information input via the common electronic page by a user after the common page has been supplied is usable, in the case of each of the links, in determining a particular page of the respective destination site to which the user is directed upon activation of the respective link in said common electronic page.

6. A method according to any preceding claim in which the step of supplying at least one electronic page comprises the step of supplying a first input page before supplying said common page.

7. A method according to claim 6 comprising the further steps of: accepting at the central unit information input via the first input page by the user;
selecting at the central unit at least one selected destination electronic site in dependence on the information input via the page by the user; and
supplying from the central unit to the user said common page including a link to said at least one selected destination electronic site.

8. A method according to claim 3 wherein at least one link supplied to the user is a dynamic link to a destination site, the link being dynamic in the sense that whilst specifying a destination site, the particular page within that site to which the link is directed is selectable and the method comprises the step of;
upon activation of said dynamic link by the user, selecting a page of that destination site on the basis of the information input by the user and directing the user to the selected page of the destination site, whereby the user may browse pages from the destination site starting from the selected page.

9. A method according to any preceding claim in which the information supplied to the destination electronic site is supplied directly from the user.

10. A method according to any preceding claim in which the common page includes a plurality of links to respective destination electronic sites.

11. A method according to claim 10 comprising the further step of, where a user visits more than one of the respective destination sites, supplying to each respective site at least some of the information input via the input page.

12. A method according to claim 10 or 11 in which the common page is arranged to allow a user to select a plurality of desertion sites to be visited and then activate the appropriate links simultaneously by a single action.

13. A method according to claim 12 in which said appropriate links selectable consist of all links on that common page or only a subset of user selected links.

14. A method according to any preceding claim in which visiting a destination site by activating a link on the common page causes a respective new window to automatically open on the user's machine for the or each site visited, wherein where at least one window is opened for a respective destination site pages from the respective destination site can be browsed in the window.

15. A method according to any one of claims 1 to 13 in which visiting a destination site by activating a link on the common page causes a selectable number of new windows to open on the user's machine for the or each site visited, in which window(s) pages from the restive destination site can be browse.

16. A method according to claim 14 or claim 15 in which the or each window is a virtual window.

17. A method according to any preceding claim in which a user may use the portal electronic site and supply information yet remain anonymous by virtue of not having to rester or log-on.

18. A method according to any preceding claim in which the input page facilitates the input of information on the basis of which, information items are forwarded to a destination site, on link activation, to enable that site to at least one of dynamically select and dynamically modify electronic pages to be forwarded to the user.

19. A method according to any preceding claim comprising the further step of pre-processing the input information prior to forwarding to a destination site on link activation.

20. A method according to any preceding claim comprising the step of controlling, on the basis of the input information, the contents of the page provided to the user from a destination site selected by link activation.

21. A method according to any preceding claim in which the input page facilitates the input of activity specific information, which information is related only to a current activity.

22. A method according to any preceding claim in which the input page facilitates the input of user specific information and activity specific information.

23. A method according to claim 21 wherein the activity specific information comprises item specific information and contextual information.

24. A method according to any preceding claim comprising the steps of establishing a session when a first page is supplied from the central unit to the user, terminating the session when the user leaves the portal site administered by the central unit and retaining the information input by the user via the input page only for the duration of the session.

25. A method according to any preceding claim in which of the links on the common page, those links to destination sites which will accept information from the portal electronic site are distinguishable to a user from those links to destination sites that do not accept the information.

26. A method of operating an end user communications unit arranged for receiving services provided over a network comprising the steps of:
receiving over the network from a portal electronic site at a central unit, one or more electronic pages, at least one of the pages acting as an input page facilitating input of information by the user and at least one of the pages acting as a link page including at least one link to a respective destination electronic site;
the method comprising the further steps of, when said at least one link is activated by a user after the user has input information via the input page;
i) directing the user to the respective destination electronic site so that a user can browse pages from the respective site; and
ii) supplying to the respective destination electronic site at least some of the information input by the user via the input page, wherein no direct interaction between the central unit and the respective destination site is required to allow said at least some of the information to be supplied to the respective destination site.

27. A method according to claim 26 in which the link page is arranged to allow a user to select a plurality of destination sites to be visited and then activate the appropriate links simultaneously by a single action.

28. A method according to claim 26 or claim 27 comprising the step of causing a new window to open in respect of each activated link.

29. A method according to any one of claims 26 to 28 in which the input page facilitates the input of information on the basis of which, information items are forwarded to a destination site, on link activation, to enable that site to at least one of dynamically select and dynamically modify electronic pages to be forwarded to the user.

30. A method according to any one of claims 26 to 29 wherein at least one link received by the user is a dynamic link to a destination site, the link being dynamic in the sense that whilst specifying a destination site, the particular page within that site to which the link is directed is selectable and the method comprises the step of.
upon activation of said dynamic link by the user, selecting a page of that destination site on the basis of the information input by the user and directing the user to the selected page of the destination site, whereby the user may browse pages from the destination site starting from the selected page.

31. A method according to any one of claims 26 to 30 comprising the step of controlling, on the basis of the input information, the identity and/or contents of the page provided to the user from a destination site selected by link activation.

32. A method according to any one of claims 26 to 31 in which information input by a user after a link page has been received is useable in selecting a particular page of a destination site to which the user is to be directed and for is forwardable to a destination site, upon activation of the respective link in said link page.

33. A method for facilitating use of services provided over a network comprising the steps of:
maintaining a portal electric site at a central unit;
supplying over the network from the central unit to a user, one or more electronic pages at least one of the pages acting as an input page facilitating input of information by the user and at least one of the pages acting as a link page including at least one dynamic link to a respective destination electronic site, the link being dynamic in the sense that whilst specifying a destination site, the particular page within that site to which the link is directed is selectable;
the method comprising the further steps of;
receiving information input via the input page; and
upon activation of said dynamic link by the user after information input, selecting a page of that destination site on the basis of the information input by the user and directing the user to the selected page of the destination site whereby the user may browse pages from the destination site starting from the selected page.

34. A method according to claim 33 comprising the step of:
arranging for at least some of the information input by the user via the input page to be supplied to the respective destination electronic site.

35. A method according to claim 33 or claim 34 in which the link page is arranged to allow a user to select a plurality of destination sites to be visited and then activate the appropriate links simultaneously by a single action.

36. A method according to any one of claims 33 to 35 comprising the stop of causing a new window to open in respect of each activated link.

37. A method according to any one of claims 33 to 36 in which the input page facilitates the input information which is forwarded to a destination site on link activation to enable that site to at least one of dynamically select and dynamically modify electronic pages to be forwarded to the use.

38. A method according to any one of claims 33 to 37 comprising the step of controlling, on the basis of the input information the identity and/or contents of the page provided to the user from a destination site selected by link activation.

39. A computer program comprising code portions which when loaded and run on a computer cause the computer to carry out a method according to any preceding claim.

40. A method for tailoring services provided over a network comprising the steps of:
maintaining a portal electronic site at a central unit;
supplying over the network from the central unit to a user, one or more electronic pages, at least one of the pages acting as an input page facilitating input of information by the user and at least one of the pages acting as a link page including at least one link to a respective destination electronic site;
the method comprising the other steps of, when said at least one link is activated by a user after the user has input information via the input page:
i) directing the user to the respective destination electronic site so that a user can browse pages from the respective site; and
ii) supplying to the respective destination electronic site at least some of the information input by the user via the input page to allow tailoring of the destination site, wherein no direct interaction between the central unit and the respective destination site is required to allow said at least some of the information to be supplied to the respective destination site.

41. A method according to claim 40 comprising the further step of tailoring the destination site upon receipt of said information.

42. A method according to claim 40 or claim 41 comprising the step of causing a new window to open in respect of each activated link.

43. A method for facilitating use of services provided over a network comprising the steps of:
maintaining an electronic site at a central unit;
supplying over the network from the central unit to an end user communication unit an electronic page, which page includes a plurality of links to respective destination electronic sites, wherein the page facilitates user selection of from said plurality and comprises a link activation object, the link activation object being such that, when operated by an end user it causes each selected link to be activated, whereby the selected links are activateable simultaneously by a single user action.

44. A method of operating an end user communication unit arranged for receiving services provided over a network comprising the step of:
receiving over the network from a central unit, an electric page, which page includes a plurality of links to respective destination electronic sites, wherein the page facilitates user selection of links from said plurality and comprises a link activation object, and the method comprises the further steps of accepting user selection of said links to destination sites and in response to operation of the link activation object, activating each of the selected links, whereby the selected links are activated simultaneously by a single user action.

45. A method according to claim 43 or 44 in which the page facilitates user selection of links in at least two subsets and comprises a plurality of link activation objects each arranged for simultaneously activating the links in a respective subset.

46. A method according to any one of claims 43 to 45 comprising the step of causing a new window to open in respect of each activated link.

47. A method according to any one of claims 43 to 46 wherein at least one link supplied to the user is a dynamic link to a destination site, the link being dynamic in the sense that whilst specifying a destination site, the particular page within that site to which he link is directed is selectable and the method comprises the step of:
receiving information input by a user via a page supplied form the central unit; and
upon activation of said dynamic link by the user, selecting a page of that destination site on the basis of the information input by the user and directing the user to the selected page of the destination site, whereby the user may browse pages from the destination site starting from the selected page.

48. A method according to any one of claims 43 to 46 comprising the steps of:
receiving information input by a user via a page supplied form the central unit; and
controlling, on the basis of the input information, the identity and/or contents of the page provided to the user from a destination site selected by link activation.

49. A method of targeted promotion comprising the steps of:
providing a user accessible promotion depository;
allowing placing of promotions in the depository;
and controlling the placing of promotions in the depository.

50. A method according to claim 49 in which the depository is accessible at a portable electronic site via a network.

51. A method according to claim 49 or claim 50 comprising the step of gathering information about a user and providing this to a third party to allow customisation of promotions.

52. A computer program comprising code portions which when loaded and run on a computer cause the computer to carry out a method according to any one of claims 40 to 51.

53. A computer program product comprising computer readable media carrying code portions which when loaded and run on a computer cause the computer to carry out a method according to any proceeding claim.
